(19) United States
(12) Patent Application Publication
(10) Pub. No.: US 2013/0147545 A1
(43) Pub. Date: Jun. 13, 2013

(54) REFERENCE VOLTAGE GENERATION CIRCUIT AND INTERNAL VOLTAGE GENERATION CIRCUIT USING THE SAME

(71) Applicant: Young Joo KIM, Hwaseong-si Gyeonggi-do (KR)

(72) Inventor: Young Joo KIM, Hwaseong-si Gyeonggi-do (KR)

(73) Assignee: HYNIX SEMICONDUCTOR INC., Ichon-si Gyeonggi-do (KR)

(21) Appl. No.: 13/452,066

(22) Filed: Apr. 20, 2012

(30) Foreign Application Priority Data
Dec. 9, 2011 (KR) 10-2011-0131648

(51) Int. Cl. G05F 3/02

(52) U.S. Cl. 327/541; 323/313

(57) ABSTRACT

A reference voltage generation circuit includes a current source configured to generate a current by compensating for an internal temperature change, and output the generated current to an output node where a reference voltage is generated, and a resistor unit coupled to the output node and having a resistance value controlled in response to a control signal generated in a test mode.

### CROSS-REFERENCES TO RELATED APPLICATIONS

The present application claims priority under 35 U.S.C 119(a) to Korean Application No. 10-2011-0131648, filed on Dec. 9, 2011, in the Korean intellectual property Office, which is incorporated herein by reference in its entirety set forth in full.

### BACKGROUND

Typically, a semiconductor memory device receives power supply voltage VDD and ground voltage VSS from an outside source, and generates and uses internal voltages required for internal operations. The internal voltages required for the internal operations of the semiconductor memory device may include a core voltage VCORE supplied to a memory core area, a boosting voltage VPP used for driving or overdriving a word line, and a back bias voltage VBB supplied as a bulk voltage of an NMOS transistor of a core area.

Here, the core voltage VCORE may be supplied by lowering the power supply voltage VDD inputted from outside to a predetermined level. However, the boosting voltage VPP has a higher level than the power supply voltage VDD inputted from outside, and the back bias voltage VBB maintains a lower level than the ground voltage VSS inputted from outside. Therefore, charge pump circuits are needed to supply charges for the boosting voltage VPP and the back bias voltage VBB.

As such, since the internal voltages are generated by separate internal voltage generation circuits, internal temperature changes may cause changes in the internal voltage levels generated by the internal voltage generation circuits. For example, an internal temperature change may cause the core voltage VCORE level to increase, and this internal temperature change may cause the boosting voltage VPP level to decrease. In this case, a write recovery time (tWR) fail may occur.

### SUMMARY

An embodiment of the present invention relates to a reference voltage generation circuit which is capable of offsetting changes of internal voltage levels by controlling reference voltage levels, thereby substantially preventing an operation error caused by a failure, and an internal voltage generation circuit including the same.

In one embodiment, a reference voltage generation circuit includes: a current source configured to generate a current by compensating for an internal temperature change, and output the generated current to an output node where a reference voltage is generated; and a resistor unit coupled to the output node and having a resistance value controlled in response to a control signal generated in a test mode.

In another embodiment, a reference voltage generation circuit includes: a current source configured to generate first and second currents by compensating for an internal temperature change, output the first current to a first node where a first reference voltage is generated, and output the second current to a second node where a second reference voltage is generated; a first resistor unit coupled to the first node and having a resistance value controlled in response to a first control signal generated in a test mode; and a second resistor unit coupled to the second node and having a resistance value controlled in response to a second control signal generated in a test mode.

In another embodiment, an internal voltage generation circuit is configured to: generate first and second internal voltages in response to first and second reference voltages, wherein the internal voltage generation circuit further comprises a reference voltage generation unit configured to generate the first and second reference voltages of which the voltage levels are controlled by resistance values set according to first and second control signals that are generated in a test mode.

### BRIEF DESCRIPTION OF THE DRAWINGS

The above and other aspects, features and other advantages will be more clearly understood from the following detailed description taken in conjunction with the accompanying drawings, in which:

FIG. 1 is a block diagram of an internal voltage generation circuit in accordance with an embodiment of the present invention;

FIG. 2 is a circuit diagram of a reference voltage generation unit included in the internal voltage generation circuit illustrated in FIG. 1;

FIG. 3 is a circuit diagram of a first internal voltage generation unit included in the internal voltage generation circuit illustrated in FIG. 1; and

FIG. 4 is a circuit diagram of a second internal voltage generation unit included in the internal voltage generation circuit illustrated in FIG. 1.

### DESCRIPTION OF SPECIFIC EMBODIMENTS

Hereinafter, embodiments of the present invention will be described with reference to accompanying drawings. However, the embodiments are for illustrative purposes only and are not intended to limit the scope of the invention.

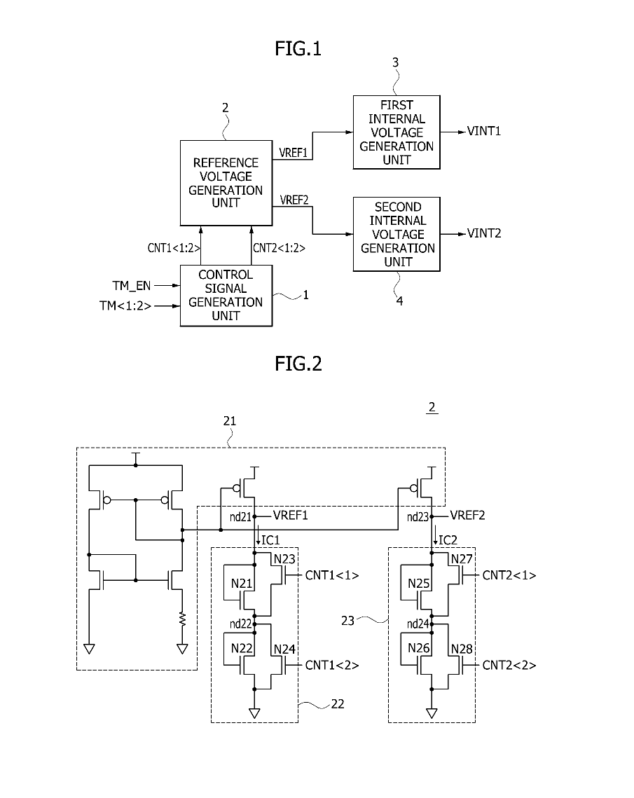

FIG. 1 is a block diagram of an internal voltage generation circuit in accordance with an embodiment of the present invention.

Referring to FIG. 1, the internal voltage generation circuit in accordance with an embodiment of the present invention includes a control signal generation unit 1, a reference voltage generation unit 2, a first internal voltage generation unit 3, and a second internal voltage generation unit 4. The control signal generation unit 1 is configured to decode a test mode signal TM<1:2> and generate first and second control signals CNT1<1:2> and CNT2<1:2> in a test mode. The control signal generation unit 1 includes a plurality of fuses of which the cutting states are configured to generate the first and second control signals CNT1<1:2> and CNT2<1:2> when the test mode has ended. The test mode is performed when a test mode enable signal TM_EN is at a logic high level, and ends when the test mode enable signal TM_EN is at a logic low level. The reference voltage generation unit 2 is configured to generate a first reference voltage VREF1 and a second reference voltage VREF2, where voltage levels of the first reference voltage VREF1 and second reference voltage VREF2 are controlled by resistance values set according to the first and second control signals CNT1<1:2> and CNT2<1:2>. The first internal voltage generation unit 3 is configured to generate a first internal voltage VINT1 in response to the first reference voltage VREF1. The second internal voltage generation unit 4 is configured to generate a second internal voltage VINT2 in response to the second reference voltage VREF2. Hereafter, referring to FIGS. 2 to 4, configurations of the reference voltage generation unit 2, the first internal voltage generation unit 3, and the second internal voltage generation unit 4 will be described in further detail as follows.

Referring to FIG. 2, the reference voltage generation unit 2 includes a current source 21, a first resistor section 22, and a second resistor section 23. The current source 21 may be implemented with a Widlar-type current source which includes MOS transistors and resistors having reverse current characteristics dependent on an internal temperature change and generates a first current IC1 and a second current IC2. The first current IC1 is outputted to a node nd21 from which the first reference voltage VREF1 is outputted, and the second current IC2 is outputted to a node nd23 from which the second reference voltage VREF2 is outputted. The first resistor section 22 includes an NMOS transistor N21, an NMOS transistor N22, an NMOS transistor N23, and an NMOS transistor N24. The NMOS transistor N21 is coupled between the node nd21 and a node nd22 and operates as a resistor. The NMOS transistor N22 is coupled between the node nd22 and a ground voltage and operates as a resistor. The NMOS transistor N23 operates as a switch element which is turned on to short the nodes nd21 and nd22 in response to the first control signal CNT1<1>. The NMOS transistor N24 operates as a switch element which is turned on to short the node nd22 to the ground voltage in response to the first control signal CNT1<2>. The second resistor section 23 includes an NMOS transistor N25, an NMOS transistor N26, an NMOS transistor N27, and an NMOS transistor N28. The NMOS transistor N25 is coupled between the node nd23 and a node nd24 and operates as a resistor. The NMOS transistor N26 is coupled between the node nd24 and a ground voltage and operates as a resistor. The NMOS transistor N27 operates as a switch element which is turned on to short the nodes nd23 and nd24 in response to the second control signal CNT2<1>. The NMOS transistor N28 operates as a switch element which is turned on to short the node nd24 to the ground voltage in response to the second control signal CNT2<2>.

The reference voltage generation unit 2 configured in such a manner controls resistance values of the first and second resistor sections 22 and 23 according to the first and second control signals CNT1<1:2> and CNT2<1:2>, and therefore controls levels of the first and second reference voltages VREF1 and VREF2. More specifically, when the first control signal CNT1<1:2> turns on the NMOS transistor N24 which increases the resistance value of the first resistor section 22, the voltage level of the first reference voltage VREF1 increases. On the other hand, when the resistance value of the first resistor section 22 is decreased, the voltage level of the first reference voltage VREF1 decreases. Furthermore, when the second control signal CNT2<1:2> turns on the NMOS transistor N28 which increases the resistance value of the second resistor section 23, the level of the second reference voltage VREF2 increases. On the other hand, when the resistance value of the second resistor section 23 is decreased, the voltage level of the second reference voltage VREF2 decreases.

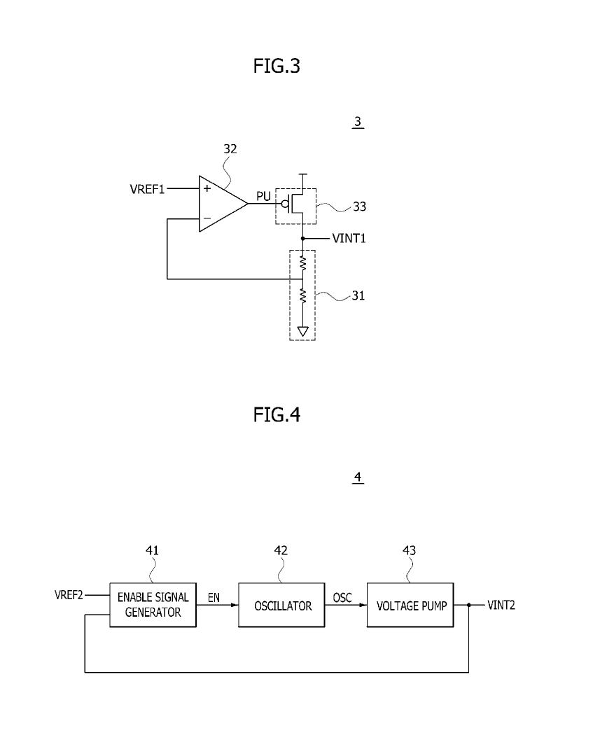

Referring to FIG. 3, the first internal voltage generation unit 3 includes a voltage divider 31, a comparator 32, and a divider 33. The voltage divider 31 is configured to divide the first internal voltage VINT1. The comparator 32 is configured to generate a pull-up signal PU which is enabled to a logic low level when the first internal voltage VINT1 has a lower level than the first reference voltage VREF1. The driver 33 is configured to drive the first internal voltage VINT1 in response to the pull-up signal PU. The level of the first internal voltage VINT1 increases when the level of the first reference voltage VREF1 increases. The first internal voltage VINT1 may be implemented with a core voltage VCORE used in a core area where memory cells of the semiconductor memory device are positioned, or the first internal voltage VINT1 may be implemented with a peri voltage VPERI used in a peri area where control circuits are positioned.

Referring to FIG. 4, the second internal voltage generation unit 4 includes an enable signal generator 41, an oscillator 42, and a voltage pump 43. The enable signal generator 41 is configured to generate an enable signal EN which is enabled to a logic high level when the second internal voltage VINT2 has a lower level than the second reference voltage VREF2. The oscillator 42 is configured to generate an oscillation signal OSC as a periodic signal when the enable signal EN is inputted at a high level. The voltage pump 43 is configured to pump the second reference voltage VREF2 in response to the oscillation signal OSC. The level of the second internal voltage VINT2 increases when the level of the second reference voltage VREF2 increases. The second internal voltage VINT2 may be implemented with a boosting voltage VPP used for driving a word line or during overdriving.

The internal voltage generation circuit configured in the above-described manner may control voltage levels of the first and second reference voltages VREF1 and VREF2 according to the first and second control signals CNT1<1:2> and CNT2<1:2> and control voltage levels of the first and second internal voltages VINT1 and VINT2, when voltage levels of the first and second internal voltages VINT1 and VINT2 are changed. The voltage levels of the first and second internal voltages VINT1 and VINT2 may be changed according to internal voltage changes, or the voltage levels of the first and second internal voltages VINT1 and VINT2 may changed because of an operation error caused when a failure occurs. The test mode for such an operation will be described in more detail as follows.

First, the internal voltage generation circuit generates the first and second control signals CNT1<1:2> and CNT2<1:2> to control levels of the first and second reference voltages VREF1 and VREF2 according to the test mode signal TM<1:2> in the test mode, where the internal voltage generation circuit enters the test mode when the test mode enable signal TM_EN is at a high-level. At this time, the internal voltage generation circuit generates the first and second internal voltage VINT1 and VINT2 according to the first and second reference voltages VREF1 and VREF2 of which the levels are controlled for each logic level combination of the first and second control signals CNT1<1:2> and CNT2<1:2>, and the internal voltage generation circuit checks whether an operation error occurs. Such a process may be performed under a plurality of internal temperature conditions. The internal voltage generation circuit checks a logic level combination of the first and second control signals CNT1<1:2>and CNT2<1:2>, in which an operation error does not occur, through the test mode.

When the test mode ends, the internal voltage generation circuit controls the cutting states of the fuses included in the control signal generation unit 1 according to the logic level combination of the first and second control signals CNT1<1:2> and CNT2<1:2>which was checked during the test mode. Therefore, the first and second reference voltages VREF1 and VREF2 are generated based on the logic level combination of the first and second control signals CNT1<1:2> and CNT2<1:2>, in which an operation error does not occur during the test mode. Thus, the first and second reference voltages VREF1 and VREF2 may be used for generating the first and second internal voltages VINT1 and VINT2.

Is short, the internal voltage generation circuit in accordance with an embodiment of the present invention may offset changes in the internal voltage levels caused by temperature changes, by controlling the reference voltage levels. Offsetting changes in the internal voltage levels may make it possible to substantially prevent operation errors caused by failures.

In accordance with embodiments of the present invention, changes in internal voltage levels may be offset by controlling reference voltage levels, which makes it possible to substantially prevent operation errors caused by a failure.

The embodiments of the present invention have been disclosed above for illustrative purposes. Those skilled in the art will appreciate that various modifications, additions and substitutions are possible, without departing from the scope and spirit of the invention as disclosed in the accompanying claims.

What is claimed is:

1. A reference voltage generation circuit comprising:
a current source configured to generate a current by compensating for an internal temperature change, and output the generated current to an output node where a reference voltage is generated; and
a resistor unit coupled to the output node and having a resistance value controlled in response to a control signal generated in a test mode.

2. The reference voltage generation circuit of claim 1, further comprising:
a control signal generation unit configured to decode a test mode signal and generate the control signal based on the test mode signal, wherein the control signal generation unit comprises a plurality of fuses which are cut to generate the control signal when the test mode is ended.

3. The reference voltage generation circuit of claim 1, wherein the resistor unit comprises:
a resistor coupled between the output node and a ground voltage; and
a switch element coupled in parallel to the resistor between the output node and the ground voltage and turned on in response to the control signal.

4. The reference voltage generation circuit of claim 3, wherein the resistor comprises a diode.

5. A reference voltage generation circuit comprising:
a current source configured to generate first and second currents by compensating for an internal temperature change, output the first current to a first node where a first reference voltage is generated, and output the second current to a second node where a second reference voltage is generated;
a first resistor unit coupled to the first node and having a resistance value controlled in response to a first control signal generated in a test mode; and
a second resistor unit coupled to the second node and having a resistance value controlled in response to a second control signal generated in the test mode.

6. The reference voltage generation circuit of claim 5, further comprising:
a control signal generation unit configured to decode a test mode signal and generate the first and second control signals based on the test mode signal, wherein the control signal generation unit comprises a plurality of fuses which are cut to generate the first and second control signals when the test mode is ended.

7. The reference voltage generation circuit of claim 5, wherein the first resistor unit comprises:
a resistor coupled between the first node and a ground voltage; and
a switch element coupled in parallel to the resistor between the first node and the ground voltage and turned on in response to the first control signal.

8. The reference voltage generation circuit of claim 7, wherein the resistor comprises a diode.

9. The reference voltage generation circuit of claim 5, wherein the second resistor unit comprises:
a resistor coupled between the second node and a ground voltage; and
a switch element coupled in parallel to the resistor between the second node and the ground voltage and turned on in response to the second control signal.

10. The reference voltage generation circuit of claim 9, wherein the resistor comprises a diode.

11. An internal voltage generation circuit comprising:
a reference voltage generation unit configured to generate first and second reference voltages of which the levels are controlled by resistance values set according to first and second control signals;
a first internal voltage generation unit configured to generate a first internal voltage in response to the first reference voltage; and
a second internal voltage generation unit configured to generate a second internal voltage in response to the second reference voltage

12. The internal voltage generation circuit of claim 11, further comprising:
a control signal generation unit configured to decode a test mode signal and generate the first and second control signals in a test mode, wherein the control signal generation unit comprises a plurality of fuses which are cut to generate the first and second control signals when the test mode is ended.

13. The internal voltage generation circuit of claim 11, wherein the reference voltage generation unit comprises:
a current source configured to generate first and second currents by compensating for an internal temperature change, output the first current to a first node where the first reference voltage is generated, and output the second current to a second node where the second reference voltage is generated;
a first resistor section coupled to the first node and having a resistance value controlled in response to the first control signal; and
a second resistor section coupled to the second node and having a resistance value controlled in response to the second control signal.

14. The internal voltage generation circuit of claim 13, wherein the first resistor section comprises:
a resistor coupled between the first node and a ground voltage; and
a switch element coupled in parallel to the resistor between the first node and the ground voltage and turned on in response to the first control signal.

15. The internal voltage generation circuit of claim 14, wherein the resistor comprises a diode.

16. The internal voltage generation circuit of claim 13, wherein the second resistor section comprises:
a resistor coupled between the second node and a ground voltage; and
a switch element coupled in parallel to the resistor between the second node and the ground voltage and turned on in response to the second control signal.

17. The internal voltage generation circuit of claim 16, wherein the resistor comprises a diode.

18. The internal voltage generation circuit of claim 11, wherein the first internal voltage generation unit comprises:
a comparator configured to compare a signal obtained by dividing the first internal voltage with the first reference voltage and generate a pull-up signal; and
a driver configured to drive the first internal voltage in response to the pull-up signal.

19. The internal voltage generation circuit of claim 11, wherein the second internal voltage generation unit comprises:
an enable signal generator configured to compare the levels of the second internal voltage and the second reference voltage and generate an enable signal;
an oscillator configured to generate an oscillation signal in response to the enable signal; and
a voltage pump configured to pump the second internal voltage in response to the oscillation signal.
